(19) United States
(12) Patent Application Publication
(10) Pub. No.: US 2005/0040197 A1
(43) Pub. Date: Feb. 24, 2005

(54) "Cargo Backpack" luggage-space saver for SUV or van's

(76) Inventors: Johann Leon Botha, Austin, TX (US); Zelda-Rina Botha, Austin, TX (US)

Correspondence Address: JOHANN & ZELDA BOTHN, 2206 HASKELL STREET, AUSTIN, TX, 78702, US

(21) Appl. No.: 10/648,610

(22) Filed: Aug. 21, 2003

(51) Int. Cl. B62J 11/00; B62J 7/00; B62J 9/00

(52) U.S. Cl. 224/414; 224/427; 224/431; 224/926

(57) ABSTRACT

A Luggage-Space Saver (called a “Cargo Backpack”) for an SUV, Pick up Truck (or Van), or any smaller vehicle, attached to the rear of the vehicle by sliding the shaft (part of a Supporting Platform), at the bottom of the “Cargo Backpack”, into the Receiver hitch of the vehicle. Depending on how the back door of the vehicle opens, said “Backpack” would at least partially cover the rear of the vehicle in a closed state. The Luggage-Space Saver “Backpack” has a Supporting Platform that is reinforced with metal plates next to the main steel bar that slides into the 2 X 2 Receiver hitch of the vehicle and a pivoting closing lid. It is a very simple idea but yet a great space saver.

### BACKGROUND

1. Field of the Invention

The invention relates to any vehicle that is equipped with a receiver hitch at the back. Currently the focus is on vehicles that are equipped with a 2×2 receiver hitch but this invention will allow us to, at a later stage, include smaller vehicles that are equipped with a 1¼×1¼ receiver hitch.

Often, when larger families take a road trip, they need more luggage space and from personal experience, this can be a major problem. Also, on long trips, a “Cargo Backpack” that is installed at the rear of the vehicle will allow for easy access to luggage and coolers etc. during the trip. A “Cargo Backpack” at the rear of the vehicle will definitely provide more safety and allow better fuel economy than when luggage is stored on top of the roof of the vehicle. Once the “Cargo Backpack” is installed, it will partially cover the back end of the vehicle however, neither the tail lights of the vehicle, nor the driver's rear view will be obscured by the “Cargo Backpack”. The driver will still be able to use his/her rear view mirror as usual.

2. Description of the Prior Art

We found that the modern design and manufacture of vehicles (even SUV's) does not allow sufficient luggage-space volume to allow a family of 6, to comfortably load all their luggage with regard to keeping a sufficient luggage-space volume available inside the vehicle. The “Cargo backpack” allows for more options and sufficient flexibility when loading the luggage-space volume since there is now more space left inside the vehicle.

### SUMMARY OF THE INVENTION

It is the object of the invention to provide the consumer with different choices of a Space Saver Luggage “Backpack” (Box) that is no more than 3 feet deep and is easily attached to the vehicle by sliding the 2×2 steel bar into the 2×2 receiver hitch. The depth of the “Cargo Backpack” can be customized to the design of the vehicle and the specific needs of the consumer.

The main object of the invention is to provide larger families (such as our own), more options to accommodate luggage while traveling on long and/or vacation trips and to have enough space available for a comfortable and stress-free trip. With most of the “larger” luggage pieces tucked away in the “Cargo Backpack”, valuable space will be gained inside the vehicle to accommodate smaller bags such as coolers, handbags, and diaper bags which often needs to be within arms reach. Another advantage of the “Cargo Backpack” is that luggage inside in the back of the vehicle should never again have to be stacked up “to the roof” and the driver's rear view visibility obscured. Since the “Cargo Backpack” is mounted at the back of the vehicle, it provides for great aerodynamic airflow and minimum wind resistance. A big plus for the “Cargo Backpack” is that it attaches and detaches within seconds. When not in use “on the vehicle”, the design of the “Cargo Backpack” allows for it to easily be used in- or outdoors as supplemental storage. The “Cargo Backpack” is not only a plus for large families, it also can serve as a great accessory on any vehicle where more space for luggage and/or other, is needed.

### BRIEF DESCRIPTION OF THE DRAWINGS

FIG. 1 shows a view of an SUV vehicle in the closed state, with a Cargo Backpack on. With the lid closed

FIG. 2 shows a Space Saver Luggage “Cargo Backpack” (Box) for a vehicle in accordance with FIG. 1 with the pivoting lid in the “closed” position.

FIG. 3 shows the Space Saver Luggage “Cargo Backpack” (Box) all by itself in dimensions, it also shows the steel bar sliding into a 2×2 inch receiver hitch

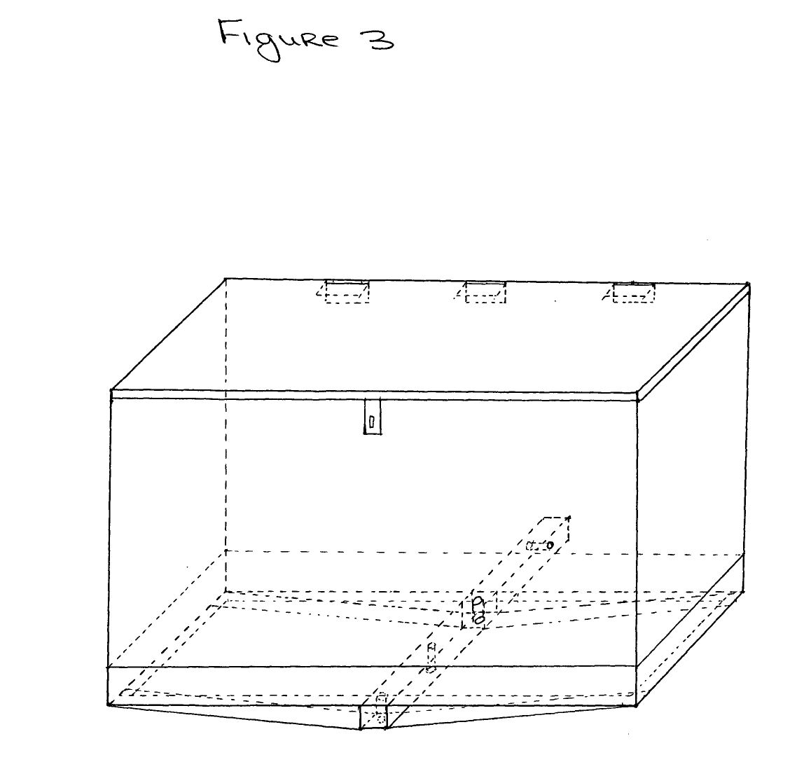

FIG. 4 shows Cargo Supporting Platform from the top with steel bar sliding into receiver hitch secured with a safety pin

### DETAILED DESCRIPTION OF A PREFERRED EMBODIMENT

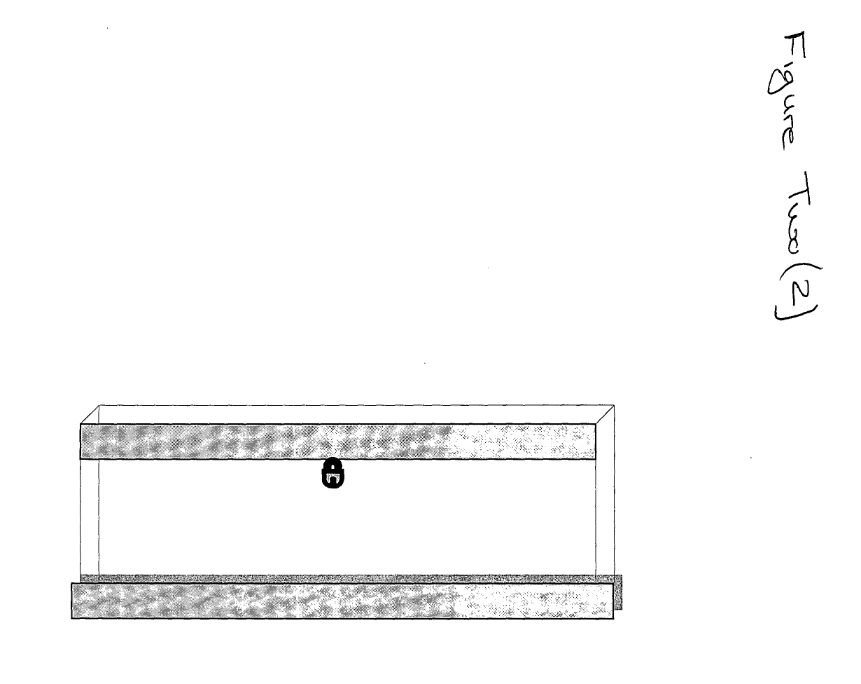

As shown in FIG. 2, a Luggage-Space Saver (called a “Cargo Backpack”) for an SUV, Pick Up Truck (or Van), or any smaller vehicle, attached to the rear end of the vehicle by sliding the 4×4 steel bar (part of Supporting Platform), at the bottom of the “Cargo Backpack”, into the Receiver hitch of the vehicle.

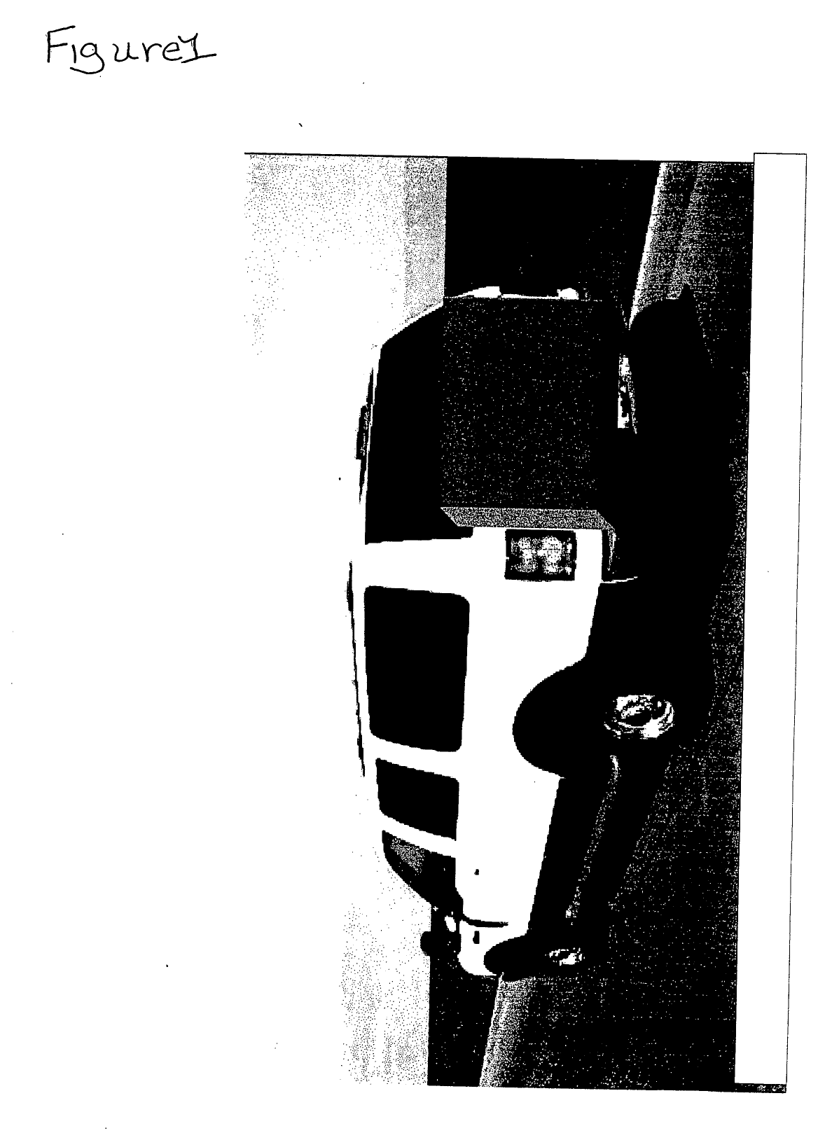

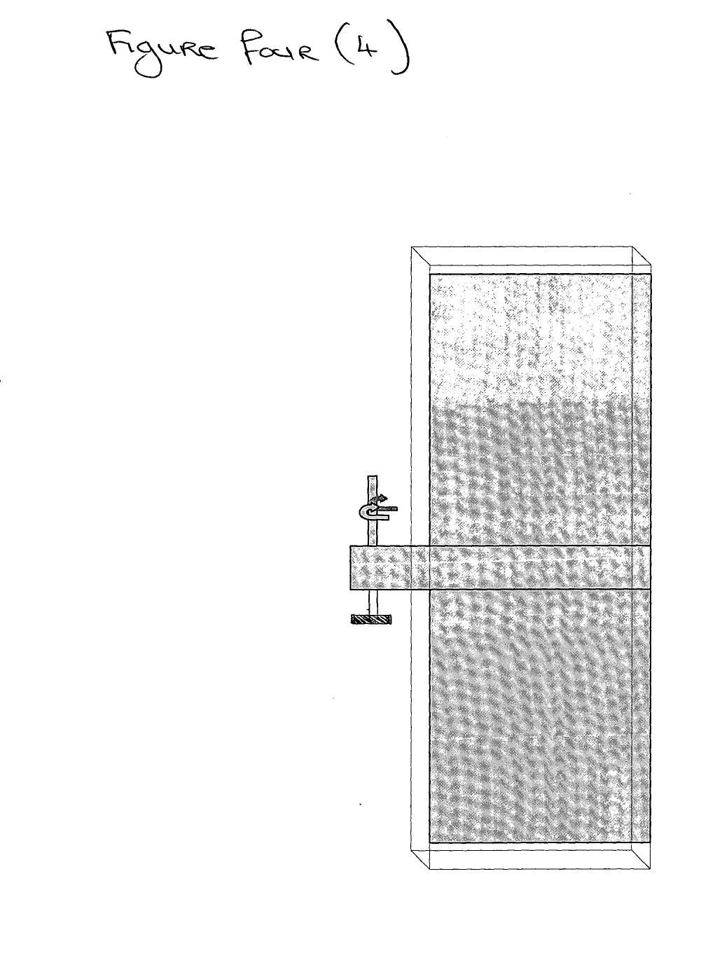

As shown in FIG. 4 and FIG. 1, The “Cargo Backpack” is designed and constructed on a frame element or supporting Platform and is being arranged in the rear area of the vehicle in such a way that it would not obscure the rear view for the driver (from inside the vehicle), nor block the visibility of the tail lights of said vehicle from other drivers traveling behind you.

A shown on FIG. 4, The Supporting Platform has a base construction reinforced by metal bars next to the main steel bar that slides into the 2×2 Receiver hitch. The “Cargo Backpack” (or Box) is aero dynamic and seal weather proof, with a visible lock. The Backpack itself is customized in size and depth to allow for a proper fit in accordance to the vehicle design. The “Cargo Backpack” (or Box) is not deeper than 3 feet and not less than 1, 5 feet deep. It opens by means of a pivoting lid at the top of the Backpack that can also be locked down.

The invention operates as follows:

The Space Saver Luggage “Cargo Backpack” (Box) is stored and only used on a per need basis. Usually for long trips where you need more space in the vehicle or when you have an access of luggage

1. By utilizing the “Cargo Backpack”, maximum possible luggage-space volume is available for loading purposes. To gain access into the “Backpack”, the pivoting lid (at top) must be opened.

The Luggage Space Saver “Cargo Backpack” (Box) has metal plates (supports) build into the Supporting Platform at the bottom to reinforce the design and will help support the luggage. Care should be taken when loading the “Cargo Backpack”. The heaviest items should always be packed at the bottom in the center above the steel beam that slide into the 2×2 receiver hitch. With the heaviest luggage pieces packed in the middle at the bottom, one can then work your way to the sides and the top with the smaller and lighter luggage pieces at the very top.

2. Whenever the Luggage Space Saver “Backpack” (Box) is needed, it can just be lifted up and the (2×2) steel bar be slid into position in the 2×2 receiver hitch on the vehicle. A safety pin with safety clip secures the “Cargo Backpack” in place. While driving, the lid should always be locked down with a padlock.

1. We claim: A Luggage Saver for a SWV, P/U Truck or VAN or other vehicle, comprising of a loose attachment that would partially cover the rear of the vehicle and that can prevent the back door to be opened. Different sizes will be available and depending on the size and design of the vehicle, the back window (above back door), will still yield access;
we claim: a frame or Supporting Platform said frame Cargo Platform mounted in the rear of the vehicle, the platform has a steel bar sliding into a 2×2 receiver hitch secured with a safety clip;
A Luggage Space Saver “Cargo Backpack” (Box) with a pivoting closing lid with said “Backpack” mounted on top of the Supporting Platform; The prototype “Cargo Backpack” (Box) comes in a rectangular shape with a height that range from 2 foot to 3 feet deep. As demand increase, more variations will become available. The said Luggage Space Saver “Cargo Backpack” (including the Supporting Platform), can easily be removed from the vehicle and stored when not needed;
according to claim 1, wherein the Luggage Saver “Cargo Backpack” (Box) is constructed on the Supporting Platform. The Supporting Platform is 5 feet wide×18 inches deep×3 inches high with one main steel bar in the middle that slides into a 2×2 receiver hitch. On either side of the main steel bar, there are supporting metal plates to reinforce the platform.
We claim The Luggage Saver “Cargo Backpack” (Box) will become available in different heights as consumer needs develop: currently, the basic size offered is one that is 2 feet deep and one that is 3 feet deep. The different sizes should allow all consumers the convenience of opening and closing the rear window (above back door).
We claim an aerodynamic lightweight “Cargo Backpack” that attaches to a 2×2 receiver hitch secured by a safety pin and safety clip. The “Cargo Backpack” has a pivoting lid that is secured to its back wall with hinges and allows for it to be locked protecting the contents from weather and loss.
